(19) United States
(12) Patent Application Publication
(10) Pub. No.: US 2024/0209535 A1
(43) Pub. Date: Jun. 27, 2024

(54) FLUID STORAGE

(71) Applicant: Polyflow LLC, Midland, TX (US)

(72) Inventors: Malcolm Rosenow, Aiken, SC (US); Rafik Boubenider, Cypress, TX (US)

(21) Appl. No.: 18/146,088

(22) Filed: Dec. 23, 2022

(51) Int. Cl. C25B 15/08; C25B 1/04; F16L 11/08; F17C 5/00; F17C 7/00

(52) U.S. Cl. CPC C25B 15/08; C25B 1/04; F16L 11/081; F17C 5/00; F17C 7/00; F16L 2011/047

(57) ABSTRACT

A method and apparatus for storing at least one fluid, and a flexible fluid storage pipe are disclosed. The method comprises: via a production device, providing a desired quantity of at least one fluid to be stored; transporting the quantity of fluid from the production device into at least one flexible pipe member via at least one fluid import region of the flexible pipe member, the flexible pipe member being windable around a spool element and comprising an inner fluid retaining layer that defines a bore region of the flexible pipe member, an outer sheath disposed over and coaxial with the inner fluid retaining layer and at least one composite reinforcement layer comprising helically wound fibre reinforced thermoplastic tapes that is disposed between the inner fluid retaining layer and the outer sheath; closing the fluid import region of the flexible pipe member to thereby retain the quantity of fluid in the bore region of the flexible pipe member; and storing the quantity of fluid at a first pressure in the bore region.

### FIELD

The embodiments disclosed herein relate to a method and apparatus for storing at least one fluid, and to a flexible fluid storage pipe. For example and without limitation, embodiments disclosed herein relate to the storage of a relatively large volume of hydrogen gas at a relatively low pressure in a flexible pipe.

### BACKGROUND

Flexible pipes are widely used in the oil and gas industry in both onshore and offshore applications for the transportation of oil, gas, water, or other fluids from one location to another. Offshore flexible pipe is particularly useful in connecting sea-level supporting structures and subsea locations (which may be deep underwater, say 1000 metres or more), where the pipe may act as a riser. Onshore flexible pipe is typically arranged underground or on the surface of the ground to connect two onshore structures, and to transport a fluid from one of these structures to another. Due to their location in use, flexible pipes are exposed to a range of challenging conditions that may have high pressures, seawater, high tensile strain, and corrosive environments, for example. Flexible pipe body is therefore often composed of several concentric polymeric, metallic, and/or composite layers. For example, pipe body may include polymer and metal layers, or polymer and composite layers, or polymer, metal and composite layers. Layers may be formed from a single piece such as an extruded tube or by helically winding one or more wires or tapes at a desired pitch or by connecting together multiple discrete hoops that are arranged concentrically side-by-side. Depending upon the layers of flexible pipe used and the type of flexible pipe some of the pipe layers may be bonded together or remain unbonded. The polymeric layers generally provide sealing from fluids and/or dirt ingress and the composite and/or metallic layers provide structural rigidity.

Recently, there has been a drive to utilise alternative sources of energy. In particular, in the current climate of global warming, pollution, and dwindling fossil fuels, it is becoming more and more important to produce clean and/or renewable energy. One such source of energy is hydrogen which can be produced, for example, from water via electrolysis. In particular, so-called green hydrogen can be produced via electrolysis of water using renewable energy such as that produced at wind turbine facilities.

There is a need to store hydrogen following production before it can be utilised as an energy source. Hydrogen can sometimes be stored in a gaseous state or in a liquid state, however hydrogen storage in either state is typically a challenging and expensive endeavour. For example, hydrogen is a lightweight gas and occupies a much larger volume than many other gases under normal atmospheric pressure. To store 1 kg of hydrogen gas at atmospheric pressure, a container volume of 12300 L would be required. This is often commercially unfeasible. In addition to this, hydrogen gas is highly permeable and can sometimes penetrate layers of some storage containers. Furthermore, exposure of metallic container components to hydrogen gas can sometimes result in the weakening of said components and therefore in a weakening and possible failure of the container. This is sometimes referred to as hydrogen embrittlement. Storing hydrogen as a liquid by contrast can help mitigate some of these problems but often requires using cryogenic temperatures to prevent the hydrogen from boiling back into a gas at −252.8° C., at atmospheric pressures, and even then there is often around 4% volume loss due to “boil off” from the liquid. Thus, storage of liquid hydrogen is typically not viable from a commercial viewpoint.

In order to store hydrogen in a gaseous state, in order to increase hydrogen density and reduce necessary storage container size, carbon fibre filament wound high-rated pressure vessels operating at 350 to 700 bar (5000 to 10,000 psi) are sometimes utilised. In particular Type III and Type IV vessels are sometimes used to store hydrogen at 350, 500 or 700 bar to attempt to increase the mass of hydrogen in a containment system. Type III vessels sometimes include an aluminium liner and Type IV vessels sometimes include a high-density polyethylene liner which acts solely as the hydrogen permeation barrier, and are sometimes composite overwrapped pressure vessels also known as COPY.

A variety of differently sized Type-III and Type-IV pressure vessels are sometimes used to store hydrogen gas. For example, a 290 L capacity Type-IV vessel operating at a pressure of 350 bar sometimes stores around 6.7 kg of hydrogen gas. A 300 L capacity Type-IV vessel operating at a pressure of 500 bar sometimes stores around 9.3 kg of hydrogen gas. A 180 L capacity Type-IV vessel operating at 700 bar sometimes stores around 7.0 kg of hydrogen gas. Such pressure vessels store a limited amount of hydrogen gas and can be expensive. A large cost associated with such pressure vessels is the carbon fibre required for their manufacture. The necessity to use these types of pressure vessels for hydrogen storage significantly reduces how attractive hydrogen production and storage is from a commercial viewpoint. Additionally, storage of hydrogen gas at these high pressures often raises safely concerns.

There is therefore a need for improved hydrogen storage that is safer, less expensive, and less restrictive when compared with conventional methods.

### SUMMARY

It is an aim of certain embodiments disclosed herein to at least partly mitigate one or more of the above-mentioned problems.

It is an aim of certain embodiments disclosed herein to provide a fluid pipe which can be used to store a relatively large volume of hydrogen gas at a relatively low pressure.

It is an aim of certain embodiments disclosed herein to help reduce the costs associated with hydrogen storage.

It is an aim of certain embodiments disclosed herein to store hydrogen at a lower pressure when compared with conventional methods and thus to reduce risks associated with hydrogen storage.

It is an aim of certain embodiments disclosed herein to provide apparatus for storing at least one fluid that optionally includes hydrogen gas.

It is an aim of certain embodiments disclosed herein to provide a fluid storage pipe that optionally is suitable for storing hydrogen gas for a storage period of time.

It is an aim of certain embodiments disclosed herein to provide a flexible pipe that can be wound around a spool for storing hydrogen gas.

It is an aim of certain embodiments disclosed herein to reduce the fluid transport and compression requirements associated with storing a fluid compared with conventional methods.

It is an aim of certain embodiments disclosed herein to provide a method of storing at least one fluid that optionally includes hydrogen gas.

It is an aim of certain embodiments disclosed herein to provide a method of storing hydrogen gas underground thereby reducing space requirements for gas storage above ground level.

It is an aim of certain embodiments disclosed herein to provide a fluid pipe that is able to store a volume of hydrogen gas for an extended period of time without becoming embrittled.

According to a first aspect, there is provided a method of storing at least one fluid, comprising the steps of: via a production device, providing a desired quantity of at least one fluid to be stored; transporting the quantity of fluid from the production device into at least one flexible pipe member via at least one fluid import region of the flexible pipe member, the flexible pipe member being windable around a spool element and comprising an inner fluid retaining layer that defines a bore region of the flexible pipe member, an outer sheath disposed over and coaxial with the inner fluid retaining layer and at least one composite reinforcement layer comprising helically wound fibre reinforced thermoplastic tapes that is disposed between the inner fluid retaining layer and the outer sheath; closing the fluid import region of the flexible pipe member to thereby retain the quantity of fluid in the bore region of the flexible pipe member; and storing the quantity of fluid at a first pressure in the bore region.

In certain embodiments, the method further comprises, subsequent to closing the fluid import region, at least partially winding the flexible pipe member around a spool element, or prior to transporting the quantity of fluid from the production device into the at least one flexible pipe member, at least partially winding the flexible pipe member around a spool element.

In certain embodiments, the method further comprises transporting the quantity of fluid from the production device into the bore region via at least one valve element that is disposed at the fluid import region that, in a first configuration, fluidly connects the bore region to a fluid communication region disposed outside of the flexible pipe member.

In certain embodiments, the method further comprises, subsequent to closing the fluid import region and after a storage period of time, removing at least a portion of the quantity of fluid from the flexible pipe member via a fluid export region of the flexible pipe member that optionally is a common region of the flexible pipe member with the fluid import region.

In certain embodiments, the method further comprises, subsequent to removing a portion of the quantity of fluid from the flexible pipe member, via a compressor device, providing the portion of the quantity of fluid to a substantially rigid container and storing compressed fluid in the substantially rigid container at a further pressure that is greater than the first pressure.

In certain embodiments, the method further comprises locating the flexible pipe member across an onshore region that optionally is above ground or below ground to thereby store the quantity of fluid across said onshore region.

In certain embodiments, the method further comprises storing the said quantity of fluid at the first pressure that is less than 2000 pounds per square inch (PSI) and optionally is around 1500 PSI.

In certain embodiments, the method further comprises providing the desired quantity of at least one fluid to be stored as hydrogen that optionally is in a gaseous state and optionally storing a mass of between 30 and 50 kg (from 30 to 50 kg) of hydrogen in the bore region of the flexible pipe member that has a volume, that is a fluid storage volume, of around 4795 L along a pipe length of around 990 ft and across a bore diameter of around 5.6 inches.

In certain embodiments, the method further comprises, prior to or during transporting the quantity of fluid from the production device into the at least one flexible pipe member, compressing the quantity of fluid to be at the first pressure that optionally is a predetermined pressure.

In certain embodiments, the method further comprises limiting permeation of the fluid from the bore region radially towards the outer sheath via a permeation resistant layer that optionally is an integral part of the inner fluid retaining layer, or at least partly coats an outer surface of helical windings of the reinforcement layer.

In certain embodiments, the method further comprises providing a desired quantity of at least one fluid to be stored via electrolysis of a precursor fluid that optionally is water.

In certain embodiments, subsequent to removing said a portion of the quantity of fluid from the flexible pipe member, maintaining a remaining portion of the quantity of fluid disposed in the flexible pipe member at the first pressure by transporting a further quantity of fluid into the pipe member.

According to a second aspect, there is provided apparatus for storing at last one fluid, comprising: a flexible pipe member that is at least partially windable around a spool element and that comprises an inner fluid retaining layer that defines a bore region of the flexible pipe member, an outer sheath disposed radially around the inner fluid retaining layer and at least one composite reinforcement layer comprising helically wound fibre reinforced thermoplastic tapes disposed radially between the inner fluid retaining layer and outer sheath; wherein at least one permeation resistant region of the flexible pipe limits permeation of a desired fluid that is to be stored from the inner bore region radially towards the outer sheath.

In certain embodiments, the flexible pipe member has an outer diameter of around 6 inches, an inner diameter that is a diameter of the bore region of around 5.6 inches and a length of around 990 ft so that the bore has volume, that is a fluid storage volume, of around 4795 L so that at a pressure of around 1500 PSI the flexible pipe member can store a mass of around 30 to 50 kg (from 30 to 50 kg)of the desired fluid, the flexible pipe member optionally being disposed across an onshore region that is above ground or below ground so that the desired fluid is stored across the onshore region.

In certain embodiments, the apparatus further comprises at least one valve element that, in a first configuration, permits fluid communication of the desired fluid in the bore region between a first fluid communication region in the bore region and a further fluid communication region external to the flexible pipe member, and, in a further configuration, reduces fluid communication of the desired fluid between the first and further fluid communication regions, and optionally the valve element comprises a one-way valve that is disposed in a first configuration when the desired fluid passes from the further fluid communication region towards the first fluid communication via the valve element.

In certain embodiments, the desired fluid comprises hydrogen that optionally is in a gaseous state in storage, and wherein the valve element in the further configuration is arranged to reduce transport of hydrogen in storage between from the first fluid communication region towards the further fluid communication region.

In certain embodiments, the valve element is selectively operable to permit fluid communication of the desired fluid from the first fluid communication region towards the further fluid communication region and is selectively operable to permit fluid communication of the desired fluid from the further fluid communication region towards the first fluid communication region.

In certain embodiments, the permeation resistant region is integral with the inner fluid retaining layer or at least partly coats an outer surface of helical windings of the reinforcement layer, the permeation resistant region.

According to a third aspect, there is provided a flexible fluid storage pipe, comprising: an inner fluid retaining layer that defines a bore region; an outer sheath that is disposed over and coaxial with the inner fluid retaining layer and that comprises an outer surface of the flexible fluid storage pipe; at least one composite reinforcement layer comprising helically wound fibre reinforced thermoplastic tapes disposed between the inner fluid retaining layer and the outer sheath; and a fluid import region configured to selectively permit transport of fluid into the bore from a region exterior to the flexible fluid storage pipe; wherein a stored fluid is disposed in the bore region and a permeation resistant region disposed radially within the outer sheath limits permeation of the stored fluid from the bore region towards the outer sheath.

In certain embodiments, the stored fluid comprises hydrogen that optionally is in a gaseous state.

In certain embodiments, the flexible fluid storage pipe has an external diameter of around 6 inches, an inner diameter of around 5.6 inches that is a diameter of the bore region, and a length of around 990 ft so that the flexible fluid storage pipe is windable around a spool element and so that the bore region of the flexible fluid storage pipe has a volume, that is a fluid storage volume, of around 4795 L, and at a pressure of around 1500 PSI a mass of between 30 to 50 kg (from 30 to 50 kg) of hydrogen can be stored in the flexible fluid storage pipe that optionally is disposed across an onshore region that is above ground or below ground so that the stored fluid is stored across said onshore region.

In certain embodiments, a pressure of the stored fluid is less than 2000 pounds per square inch (PSI) and optionally is around 1500 PSI.

In certain embodiments the flexible fluid storage pipe is at least partially wound around a spool element.

According to a fourth aspect, there is provided a method of storing at least one fluid, comprising the steps of: via a production device, providing a desired quantity of at least one fluid to be stored; transporting the quantity of fluid from the production device into at least one flexible pipe member via at least one fluid import region of the flexible pipe member, the flexible pipe member being windable around a spool element and comprising an inner fluid retaining layer that defines a bore region of the flexible pipe member, an outer sheath disposed over and coaxial with the inner fluid retaining layer and at least one helically wound armour layer that is disposed between the inner fluid retaining layer and the outer sheath; closing the fluid import region of the flexible pipe member to thereby retain the quantity of fluid in the bore region of the flexible pipe member; and storing the quantity of fluid at a first pressure in the bore region.

According to a fifth aspect, there is provided apparatus for storing at last one fluid, comprising: a flexible pipe member that is at least partially windable around a spool element and that comprises an inner fluid retaining layer that defines a bore region of the flexible pipe member, an outer sheath disposed radially around the inner fluid retaining layer and at least one helically wound armour layer disposed radially between the inner fluid retaining layer and outer sheath; and at least one valve element that, in a first configuration, permits fluid communication of a desired fluid that is to be stored in the bore region between a first fluid communication region in the bore region and a further fluid communication region external to the flexible pipe member, and, in a further configuration, reduces fluid communication of the desired fluid between the first and further fluid communication regions; wherein at least one permeation resistant region of the flexible pipe limits permeation of the fluid from the inner bore region radially towards the outer sheath.

According to a sixth aspect, there is provided a flexible fluid storage pipe, comprising: an inner fluid retaining layer that defines a bore region; an outer sheath that is disposed over and coaxial with the inner fluid retaining layer and that comprises an outer surface of the flexible fluid storage pipe; at least one helically wound armour layer disposed between the inner fluid retaining layer and the outer sheath; and a fluid import region configured to selectively permit transport of fluid into the bore from a region exterior to the flexible fluid storage pipe; wherein a stored fluid is disposed in the bore region and a permeation resistant region disposed radially within the outer sheath limits permeation of the stored fluid from the bore region towards the outer sheath.

According to a seventh aspect, there is provided a method of storing at least one fluid, comprising the steps of: via a production device, providing a desired quantity of at least one fluid to be stored; transporting the quantity of fluid from the production device into at least one flexible pipe member via at least one fluid import region of the flexible pipe member, the flexible pipe member being windable around a spool element and comprising an inner fluid retaining layer that defines a bore region of the flexible pipe member and an outer sheath disposed over and coaxial with the inner fluid retaining layer; closing the fluid import region of the flexible pipe member to thereby retain the quantity of fluid in the bore region of the flexible pipe member; and storing the quantity of fluid at a first pressure in the bore region.

According to an eight aspect, there is provided a flexible fluid storage pipe, comprising: an inner fluid retaining layer that defines a bore region; an outer sheath that is disposed over and coaxial with the inner fluid retaining layer and that comprises an outer surface of the flexible fluid storage pipe; and a fluid import region configured to selectively permit transport of fluid into the bore from a region exterior to the flexible fluid storage pipe; wherein a stored fluid is disposed in the bore region and a permeation resistant region disposed radially within the outer sheath limits permeation of the stored fluid from the bore region towards the outer sheath.

Certain embodiments provide apparatus for storing at least one fluid that optionally includes hydrogen gas.

Certain embodiments provide a method of storing at least one fluid that optionally includes hydrogen gas.

Certain embodiments provide a fluid storage pipe that is suitable for storing hydrogen gas for a storage period of time.

Certain embodiments provide hydrogen gas storage at substantially lower pressures compared to conventional methods.

Certain embodiments provide safer hydrogen storage compared with conventional methods.

Certain embodiments provide a method of storing a relatively large volume of hydrogen in a single container compared with conventional methods.

Certain embodiments provide reduced necessary space on the surface of the ground for storing hydrogen gas.

Certain embodiments provide reduced reliance on carbon fibre components of containers for storage of hydrogen gas.

Certain embodiments provide a flexible pipe for storing hydrogen gas that can be wrapped around a spool in order to store the hydrogen gas in a spatially efficient manner.

Certain embodiments provide a flexible pipe for storing hydrogen gas that can be wrapped around a spool for transport of the pipe and stored hydrogen gas.

### BRIEF DESCRIPTION OF THE DRAWINGS

Some embodiments of the present disclosure will now be described hereinafter, by way of example only, with reference to the accompanying drawings in which:

FIG. 1 illustrates a flexible onshore fluid pipe;

FIG. 2 illustrates how a flexible onshore fluid pipe can be used to store hydrogen gas;

FIG. 3 illustrates how an offshore flexible pipe can be used to store hydrogen gas;

FIG. 4 illustrates a specific example of an onshore fluid storage pipe;

FIG. 5 illustrates a spooled fluid storage pipe for storing hydrogen gas; and

FIG. 6 illustrates plot of pipe capacity required to store 1 kg of hydrogen gas.

In the drawings like reference numerals refer to like parts.

### DETAILED DESCRIPTION

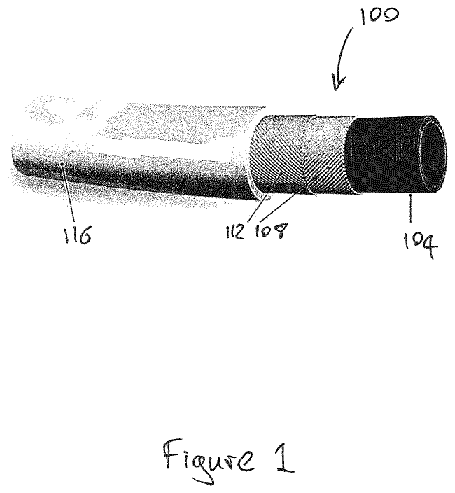

FIG. 1 illustrates an onshore fluid pipe 100. It will be understood that a flexible fluid pipe is a flexible pipe that is designed to contain fluid. It will be understood that the fluid pipe is an example of a flexible pipe member. As is illustrated in FIG. 1, the fluid pipe includes a number of concentrically arranged layers 104, 108, 112, 116. That is to say that the layers 104, 108, 112, 116 of the fluid pipe are substantially tubular and are arranged so that an inner layer 104 is disposed radially within a further layer 108 which in turn is disposed radially within a still further layer 112 that is disposed radially within an outer layer 116. It will be appreciated that, although four pipe layers are shown in FIG. 1, any other number of pipe layers may by included. The pipe may alternatively be an offshore fluid pipe. It will be appreciated that the pipe 100 of FIG. 1 is a smooth-bore pipe however a rough-bore pipe could alternatively be utilised.

The radially innermost layer 104 of the pipe 100 of FIG. 1 is a liner 104. The liner may also be referred to as an innermost fluid retaining layer. The liner 104 is manufactured from polymeric material and is at least partially impermeable with respect to a variety of fluids, for example productions fluids and the like. The liner 104 defines an internal bore of the fluid pipe 100 of FIG. 1. That is to say that the liner is an extruded non-porous polymer layer that, in use, confines a bore fluid to its internal circumference. It will be understood however that the liner instead may be a barrier layer if utilised in a rough-bore pipe arrangement and may be arranged radially around an inner reinforcing carcass layer that may include numerous interlocking windings of profiled tape of metallic material. It will be understood from FIG. 1 how the bore 120 extends along a length of the pipe. That is to say that the bore extends from one end of the pipe to the other end of the pipe. The internal bore is an example of a bore region. The liner may optionally be manufactured from high-density polyethylene (HDPE).

FIG. 1 shows how a first armour layer 108 is arranged radially around the liner 104. It will be understood that the armour layer is a reinforcement layer. The reinforcement layer may provide structural rigidity, insulation, or the like. The reinforcement layer may be composed of a plurality of layers. As shown in FIG. 1, the first armour layer includes a number of helically wound wire or tape elements wound at an angle that is offset from the major axis defined by the pipe 100. It will be appreciated that this angle defines a pitch of the windings of the tapes/wires of the first armour layer 108. It will be appreciated that the pitch of the tape windings is a winding angle of the tapes. Aptly this pitch is around 54 degrees. The skilled person will appreciate how the arrangement of the wires of the first armour layer helps protect the pipe from damage against tensile forces that may be experienced in use or in storage, for example if the pipe is stored on a spool. It will be understood that the wires utilised in the first armour layer 108 of FIG. 1 are fibre reinforced thermoplastic tapes. It will be understood that these tapes are composite tapes. Alternatively, the wires of the first armour layer could be made from steel or from any other suitable material. For example, the tapes could be manufactured any other suitable composite material or polymeric material or metallic material or the like. Although not shown in FIG. 1, each of the tapes/wires may be coated in a protective polymeric coating layer which may help protect the armour wires from damage or from corrosion and the like. Aptly as an alternative no wire coating layer is utilised. Aptly the first armour layer may be a tensile armour layer that may include evenly spaced strands of fine wires or slightly flattened rectangular metallic wires of cross-section thickness equating roughly to the thickness of the layer, arranged at a lay angle of about 30 to 55 degrees.

A further armour layer 112 is disposed radially outside/around the first armour layer 108. It will be understood that the further armour layer 112 is substantially the same as the first armour layer 108 however the helical windings of the armour wires have a winding angle that is substantially opposite to the winding angle of the helically wound wires of the first armour layer 108. It will thus be understood that the respective wires of the first armour layer and further armour layer are cross wound.

FIG. 1 also illustrates how the outermost layer of the pipe 100 is an outer sheath 116. The outer sheath is arranged radially around the further armour layer 112. It will be understood that the outer sheath 116 may instead surround different pipe layers. The outer sheath is a generally polymeric layer and is designed to prevent environmental fluid or gas or solid material ingress into the pipe. That is to say the outer sheath is an extruded non-porous polymer layer that protects the pipe's structural elements from the environment including dirt and external fluid and the like.

It will be understood that the flexible fluid pipe illustrated in FIG. 1 is unbonded. That is to say the constituent layers that make up flexible pipe body are able to slide freely relative to each other. Alternatively, a fully or partially bonded flexible fluid pipe may instead be utilised. In bonded flexible pipe body, constituent layers that make up flexible pipe body are moulded/consolidated/cured into a single structure and thus different layers cannot slide freely relative to each other. Such moulding involves the flexible pipe body layers being consolidated into one structure along some proportion of a total length of flexible pipe body. Consolidation may involve softening polymer constituents of layers such that the individual layers solidify together. Bonding can optionally be used in flexible pipe body, particularly near end fittings to improve stiffness over unbonded layers, reduce flexible pipe body failure, and the like. It will be appreciated that any portion of flexible pipe body up to and including the whole flexible pipe body or a central zone may be bonded. Bonded flexible pipe body tends to be used where there are large dynamic forces expected (as may be present from handling operations). Unbonded flexible pipe body may be used when there are large static loads.

Unbonded flexible pipe body, such as the fluid pipe illustrated in FIG. 1, may be manufactured by progressively wrapping tape of a layer over the previous layer, starting from the innermost layer progressively outwards to the outermost layer. The innermost layer of flexible pipe body is often formed by extrusion. Parameters such as lay angle and the like may be varied according to any requirements of the layer being wound, including the width of the tape (or number of wire/strand elements in the layer) and the desired pressure or tension retaining capability of the pipe. This process of wrapping the layer around the previous layer may be referred to as a winding phase. The output of the winding phase can be fed through an extruder to provide an outer protective sheath of polymer, then the resulting unbonded flexible pipe body, can be spooled and transported.

Conventionally, bonded flexible pipe body is manufactured during the manufacture of unbonded flexible pipe body. Layers of flexible pipe body are consolidated during the winding phase and/or during final sheath extrusion. For example, as reinforced tape is wound around the internal fluid retaining layer of flexible pipe body, a heat source (typically hot air, or radiant heat from an infra-red source, or using a laser) is applied to soften the polymer in the reinforced tape and/or the outer surface of the internal fluid retaining layer, to allow the reinforced tape to bond to the layer below. This process may be a vulcanisation or cross-linking process. This process of producing bonded flexible pipe body is complex and limits the rate of production of bonded flexible pipe body. Furthermore, it is not usually possible to consolidate unbonded flexible pipe body at a later or separate stage to the initial manufacture of flexible pipe body. It is not usually possible to consolidate flexible pipe body by directly heating internal components of flexible pipe body.

As indicated, the pipe of FIG. 1 is flexible. That is to say the pipe is able to flex and at least partially bend along its length. The pipe is flexible enough to be wrapped around a spool for storage. It will be appreciated how the fluid pipe of FIG. 1 can be utilised to convey a fluid that may be a gas or a liquid from one location to another. The pipe of FIG. 1 is around 990feet long to facilitate the flexible fluid pipe being wound around a spool for transport purposes. Alternatively, a pipe of any other suitable length could instead be utilised. For example the length of the pipe may be less than 990 ft. Aptly the length of the pipe may be more than 990 ft.

Although not shown in FIG. 1, the fluid pipe may include a hydrogen resistant layer. Alternatively, the hydrogen resistant layer may be part of the liner itself. That is to say a hydrogen resistant layer may be integral with the liner. Alternatively, for example if the pipe were to include metal wires in one or more armour layers, the hydrogen resistant layer may be a coating layer that covers the wires. The hydrogen resistant layer may be made from any suitable material that limits permeation of hydrogen gas.

It will be appreciated that, although not shown in FIG. 1, the fluid pipe of FIG. 1 may also hydrogen (H₂) permeation barrier to stop H₂ from passing through the pipe. It will be understood that such a hydrogen permeation barrier may be an example of a hydrogen resistant layer.

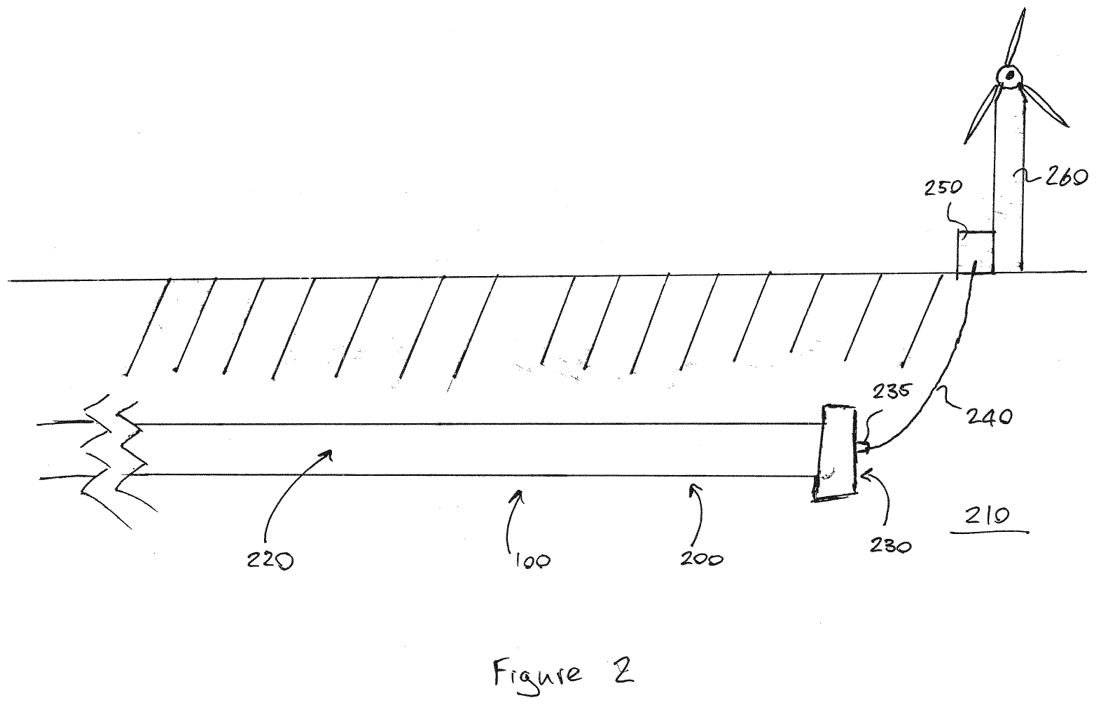

FIG. 2 illustrates how the pipe 100 of FIG. 1 can be utilised as a storage vessel 200 for a fluid. As illustrated in FIG. 2, the pipe is arranged beneath the ground 210 and is filled with hydrogen 220 in a gaseous state. It will be understood that the pipe would be arranged in a trench that is dug into the ground prior to instalment of the pipe and then covered over with earth. The pipe could of course instead be arranged on the ground, that is to say on the surface of a particular landmass, if desired. It will be appreciated that hydrogen is an example of a fluid. It will be appreciated that a fluid may be a gas or a liquid. Optionally, a mixture of fluids may instead be stored in the pipe if desired. It will be understood that hydrogen is a fluid to be stored.

As illustrated in FIG. 2, the fluid pipe includes an opening 230 for transporting fluid into the pipe for storage. The opening is a valve 235. It will be appreciated that the valve may be a one way valve. The valve may optionally instead be able to selectively allow fluid to enter the bore of the pipe and allow fluid to exit the pipe subsequent to being stored in the pipe. Alternatively, the pipe may include separate valve for import and export of fluid to and from a pipe. The valve is an example of a fluid import region. As is illustrated in FIG. 2, the valve 235 is connected to a hydrogen line 240 that is connected to a hydrogen production facility 250 that is part of an onshore wind turbine arrangement 260. It will be appreciated that the hydrogen production facility produces hydrogen from water via electrolysis. This process involves using an electrical current to separate water into hydrogen and oxygen. It will be understood that the hydrogen production facility is an example of a fluid production facility. It will be further understood that the hydrogen production facility may be a stand-alone facility or may be associated with any other suitable power generation arrangement. It will be appreciated that the pipe is located near/proximate to the hydrogen production facility. It will also be understood that fluid pipes could instead be utilised with offshore hydrogen production facilities, for example offshore wind turbines and the like. It will be appreciated that the hydrogen production facility is an example of a production device. It will be appreciated that the hydrogen line is an example of fluid communication region disposed outside of the flexible pipe member. It will be understood that should a two way valve be utilised, the valve is also an example of a fluid export region.

It will be understood how hydrogen, produced via the hydrogen production facility, can be transported directly to the fluid pipe for immediate storage. Aptly the hydrogen gas can be transported from the production facility to the pipe via pumping. It will thus be appreciated how use of a fluid pipe to store hydrogen can eliminate a need for transport of hydrogen gas to a gas compressing facility for storage at high pressure in conventional pressure vessels. It will also be appreciated how a large quantity of hydrogen can be stored at a relatively low pressure in the fluid pipe when compared with a conventional pressure vessel. The hydrogen could of course pass through a compressor device to pressurise the hydrogen prior to, or at the same time as, being transported into the fluid pipe for storage if desired. The pipe may be designed to operate at a pressure of between 100 and 150 bar (from 100 to 150 bar), for example at 100 bar or at 103 bar. The pipe may be designed to operate at a pressure of less than 2000 PSI, for example 1500 PSI. Hydrogen may thus be compressed to the pressure that the pipe is designed to operate at prior or at the same time as being transported into the pipe.

It will be appreciated how the ground in which the pipe is arranged may be remote from typical human activities. Such land is excellent for utilisation of a pipe for storing hydrogen as the pipe can be arranged to extend along land that it unused. For example, the pipe may be arranged on or under land that is substantially far away from human day to day activities and is thus distal to cities and towns. Such land is also typically where power generation facilities, such as wind turbines, are constructed which aids in the convenience of gas storage in a fluid pipe by minimising gas transport requirements.

It will be appreciated that the fluid storage pipe could instead be arranged at a location distal to the hydrogen production facility. In this situation, hydrogen gas can be produced at a power generation facility via electrolysis of water and can be compressed to a high pressure and stored in a pressure vessel. The vessel could then be transported to the fluid storage pipe via a lorry or other suitable vehicle for example. Upon reaching the location at which the fluid storage pipe is arranged, the high pressure hydrogen in the pressure vessel can be injected into the fluid pipe which operates at a lower pressure than the pressure vessel. It will be appreciated that the high pressure hydrogen could be depressurised either by injecting the high pressure hydrogen gas directly into the fluid pipe with a volume that is greater (optionally much greater) than the first vessel. Optionally the hydrogen may be passed into depressurisation equipment prior to injecting the hydrogen into the fluid pipe if necessary. In this situation, the fluid storage pipe is thus gradually filled up with hydrogen gas. It will be understood that this mode of operation of hydrogen storage reduces the number of pressure vessels required compared with conventional storage methods as the pressure vessels are reusable. That is to say that the pressure vessels are continuously being filled at the hydrogen production facility and emptied at the fluid storage pipe.

It will be understood that the act of releasing gas into another vessel of greater volume may decompress the gas that optionally is hydrogen. The second vessel must however be greater in volume for such decompression to occur. The pressures may equalize at a lower pressure due to the volume difference due to the Ideal Gas Law. For example, n=P₁V₁/(RT) and n=P₂V₂/(RT). Thus, the relation of P₁V₁/(RT)=P₂V₂/(RT) between a gas at a first pressure and in a first volume (P₁; V₁), and a gas at a second pressure and in a second volume (P₂; V₂) can be shown. As n (number of mols of gas) and RT (gas constant of gas multiplied by the temperature of the gas) is the same on either side of the shown relation between a gas a first pressure and in a first volume, and a gas at a second pressure and in a first volume, the relation becomes P₁/P₂=V₂/V₁ and thus is a ratio. If the volumes of the first and second containers are the same then the pressure of the first and second gas is the same. Thus, the act of releasing a gas into a larger volume vessel decreases the pressure. For example, if P₁=750 bar (a 750 bar pressure vessel for example) and a P₂=103 bar (a 103 bar pipe for example), then the required volume of the second container (pipe for example), to store the same amount/quantity of hydrogen as the 750 bar first container (pressure vessel for example) with a volume of V₁, is 750/103×V₁=V₂. The second vessel V₂ (pipe) thus requires a volume that is around 7.28 times larger than a volume of the first vessel, that optionally is a 750 bar pressure vessel, to store the same amount of hydrogen at 103 bar when releasing gas from said first vessel, that optionally is a 750 bar vessel, into the pipe. It will be appreciated how such an increased volume can be achieved in a pipe by utilising the pipe length over a particular area when compared with hydrogen pressure vessels. In this sense no decompression equipment is required for lowering gas pressure. Optionally any suitable decompression equipment can also be utilised. It will be appreciated that compression equipment may be used to transfer H₂ from a pipe with a larger volume (relative to a lower volume pressure vessel) into a pressure vessel with a lower volume (relative to a larger volume pipe) but at a higher pressure (relative to the pipe).

It will be understood that hydrogen gas may be stored in the fluid storage pipe for an extended period of time that is a storage period of time. This storage period of time may be days, weeks months or even years. Subsequent to storing hydrogen in the fluid storage pipe, and after the storage period, it will be necessary to remove stored hydrogen gas from the pipe in order to use the hydrogen for energy. Thus, a partial quantity of the volume of hydrogen gas stored in the fluid pipe can be removed from the fluid storage pipe as needed by transporting the hydrogen gas fluid from the bore of the fluid storage pipe, via a fluid export region of the pipe that optionally includes a valve, into a conventional storage container and transporting said container to where the hydrogen is required. In this way, quantities of hydrogen gas can be siphoned off from the fluid storage pipe as needed. Alternatively, of course, the whole fluid storage pipe which contains the stored hydrogen gas could instead be transported to where the hydrogen gas is required.

It will be understood that the hydrogen storage pipe of FIG. 2 may be arranged in other suitable environments. For example, the hydrogen storage pipe may be arranged in a solar panel farm with H₂ production capabilities and the like.

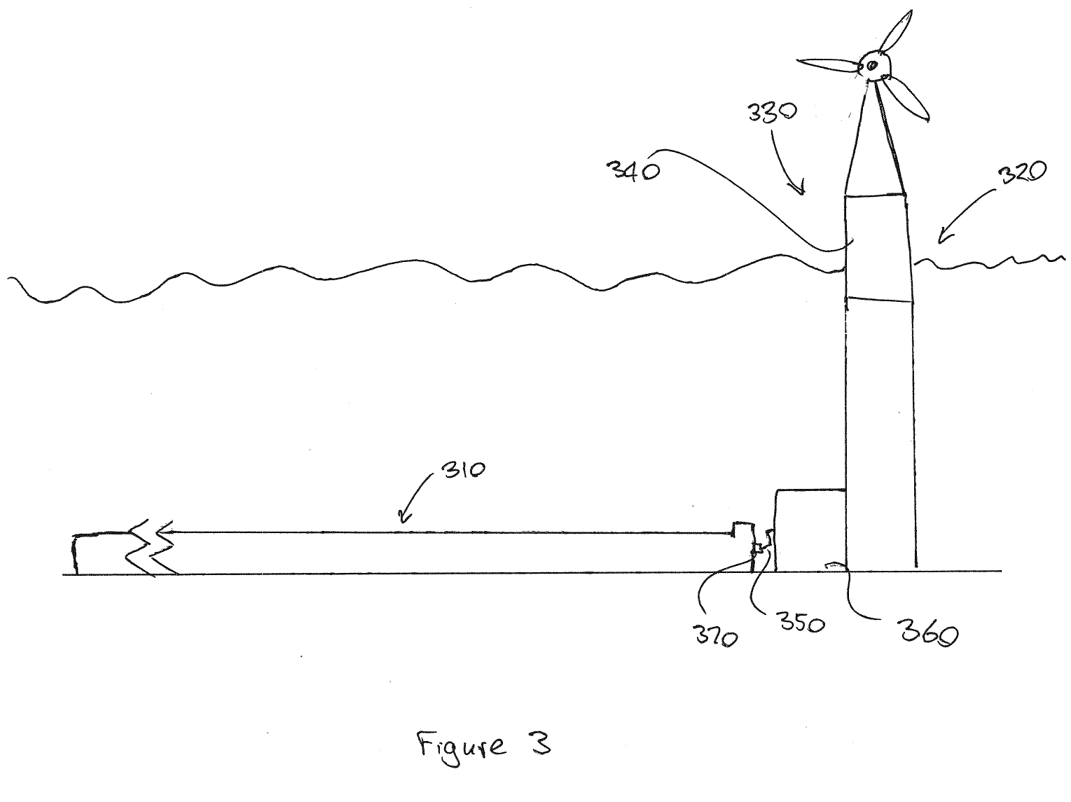

Although FIGS. 1 and 2 refer to onshore fluid pipes and power generation facilities, offshore pipes 310 could also be utilised to store hydrogen in offshore regions where offshore power generation facilities 320 are arranged. FIG. 3 illustrates such an offshore arrangement in which a fluid pipe 310 is arranged at an offshore location to receive hydrogen generated by electrolysis in an offshore wind farm 330. It will be appreciated that the offshore pipe of FIG. 3 is an offshore flexible pipe that may be a riser or the like. The pipe of FIG. 3 therefore includes a number of layers including an inner fluid retaining layer and one or more tensile armour layers that optionally include helically wound steel wires. The pipe may also include one or more pressure armour layers and an inner carcass layer.

As shown in FIG. 3, the offshore system includes an offshore wind turbine 340. Any other number of wind turbines may instead be included in the offshore system which may be an offshore wind farm. The fluid pipe 310 is connected, via a hydrogen line 350, to an electrolysis facility 360 associated with the offshore wind turbine 340. Hydrogen produced at the electrolysis facility 360 is transported directly into the fluid storage pipe 310 via the hydrogen line. It will be appreciated that the hydrogen line connects to a valve 370 of the fluid storage pipe that permits ingress of hydrogen into the bore of the fluid storage pipe but prevents flow of hydrogen in the bore of the fluid storage pipe back out through the valve. The hydrogen line and the valve thus permit transport of hydrogen gas from the electrolysis facility to into the bore of the pipe.

It will be appreciated that the fluid pipe 310 may be buoyant when filled with hydrogen gas and thus the fluid pipe may need to be secured to the seabed or weighed down. Alternatively, the fluid storage pipe 310 could be intended to float on the surface of the sea and may be stabilised with respect to the wind turbine 340 via connectors and/or ropes and/or ties and the like. For example, buoyancy setting devices such as weights or inflatable devices may be secured to the flexible pipe to achieve a desired buoyancy and/or storage shape.

It will be understood that the hydrogen gas storage principle for the system illustrated in FIG. 3 is substantially the same as the principle described with respect to FIG. 2.

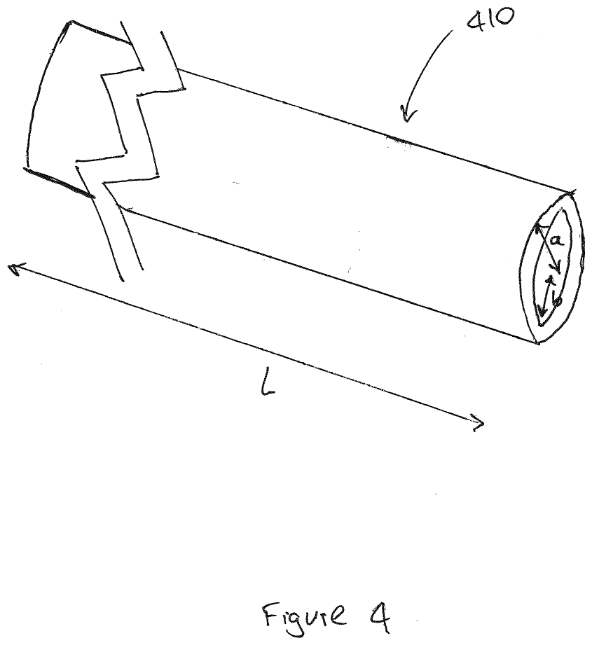

FIG. 4 illustrates a specific example of a fluid storage pipe 410 for storing hydrogen gas. The fluid pipe of FIG. 4 is similar to the fluid pipe illustrated in FIG. 1. The fluid storage pipe 410 of FIG. 4 is a 6-inch diameter glass fibre flexible composite pipe. That is to say that the fluid storage pipe of FIG. 4 has an outer diameter (a) of 6 inches. The bore diameter (b) of this pipe is 5.6 inches (142.24 mm). The fluid storage pipe 410 of FIG. 4 has a length (l) of 990 ft (302 m). The total bore capacity of the fluid pipe of FIG. 4 is thus 4795 L. The pipe of FIG. 4 is designed to operate at a pressure of 1500 psi (103 bar) and thus, via the ideal gas law and by converting moles of hydrogen gas to kg, it can be calculated the pipe can store between 30 to 50 kg (from 30 to 50 kg) of hydrogen gas, for example around 38 kg of hydrogen gas, for example around 40 kg of hydrogen gas, for example around 41.0 kg of hydrogen gas at room temperature. The fluid storage pipe 410 can thus store around 340% more hydrogen gas than conventional Type-IV pressure vessels which typically are able to store around 9.3 kg of hydrogen gas at room temperature. It will also be appreciated how hydrogen is stored at a significantly lower and safer pressure in a fluid storage pipe and how a pipe can be laid in a trench for more convenient storage compared with pressure vessels.

It will be understood that the ideal gas law can be formulated as n=RT/PV, where n is the number of moles of hydrogen, P is the pressure of the storage container, V is the volume of the storage container, R is the gas constant for hydrogen (0.083145 Liter.Bar/K-mol) and T is the temperature. It will be understood that room temperature can be considered to be around 293 K and that hydrogen gas has a molar weight of around 2.02 g/mol.

The above noted formulation also helps illustrate what length of fluid storage pipe would be required to store the same amount of hydrogen as a convention pressure vessel. It will be understood how, for two different hydrogen storage containers at the same temperature, respective ideal gas formulations can be equated to provide P₁V₁=P₂V₂, where P₁ is the pressure of the pressure vessel, V₁ is the volume of the pressure vessel P₂ is the pressure of the fluid storage pipe and V₂ is the volume of the fluid storage pipe. For a 180 L capacity Type-IV vessel operating at 700 bar (which can store around 7 kg of hydrogen gas), a 6 inch outer diameter fluid storage pipe (which has a bore diameter of 5.6 inches or 142.24 mm) operating at a pressure of 1500 psi (103 bar) requires a volume of 1223.3 L to store 7 kg of hydrogen gas. Thus a 77.03 m length of fluid storage pipe is required to store 7 kg of hydrogen gas. As described above, such a length of fluid storage pipe could be easily stored underground (in a trench or the like) or could be wound around a spool or the like.

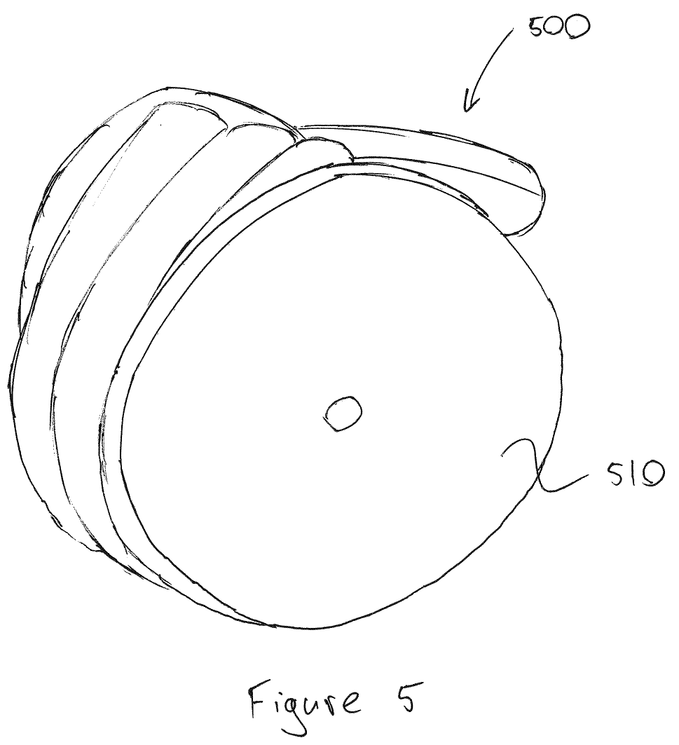

FIG. 5 illustrates a flexible fluid storage pipe 500 wound around a spool 510. It will be understood that the flexible fluid storage pipe may be wound around the spool prior to transport of fluid into the pipe. Thus, the fluid storage pipe is able to be stored and transported efficiently via wrapping around the spool. It will be appreciated the fluid storage pipe may also be wrapped around a spool following storage of hydrogen gas in the bore of the fluid storage pipe. Thus, it will be appreciated how stored hydrogen can be transported and stored efficiently by wrapping the pipe around a spool. For example, wound pipes can be stacked and the like to reduce the required footprint for storing hydrogen. It will be understood that the spool is an example of a spool element.

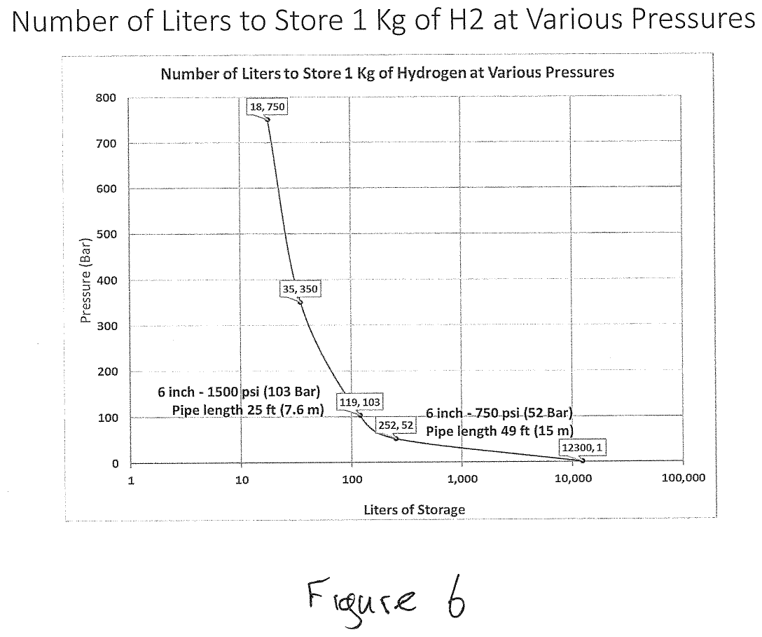

FIG. 6 illustrates a plot showing how many litres of storage capacity of a fluid storage pipe are required to store 1 kg of hydrogen gas at various pressures. As is shown in FIG. 6, if a vessel pressure of less than 100 bar is utilised, the requisite volume required in a container to store 1 kg of hydrogen gas increases dramatically. Thus, a pressure of around 100 bar is a good compromise between storing as much hydrogen gas per unit volume of the fluid storage pipe and minimising the pressure required to store hydrogen gas to reduce risks associated with high pressure storage and to reduce the need for expensive pressure resistant components such as carbon fibre. Utilising a fluid storage pipe, for example the 6 inch glass fibre composite pipe of FIG. 4 that operates at around 103 bar, operating at around 100 bar provides a good hydrogen gas storage system that can be utilised in an onshore environment either below ground (for example in a trench) on above ground.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

While certain arrangements of the inventions have been described, these arrangements have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, arrangement, or example are to be understood to be applicable to any other aspect, arrangement or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing arrangements. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some arrangements, the actual steps taken in the processes illustrated and/or disclosed may differ from those shown in the figures. Depending on the arrangement, certain of the steps described above may be removed, others may be added. Furthermore, the features and attributes of the specific arrangements disclosed above may be combined in different ways to form additional arrangements, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular arrangement. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain arrangements include, while other arrangements do not include, certain features, elements, and/or steps. Thus, such conditional language is not generally intended to imply that features, elements, and/or steps are in any way required for one or more arrangements or that one or more arrangements necessarily include logic for deciding, with or without user input or prompting, whether these features, elements, and/or steps are included or are to be performed in any particular arrangement.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain arrangements require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may be used to refer to an amount that is within less than 10% of the stated amount. As another example, in certain arrangements, the terms “generally parallel” and “substantially parallel” refer to a value, amount, or characteristic that departs from exactly parallel by less than or equal to 15°, 10°, 5°, 3°, 1 degree, or 0.1 degree. The ranges disclosed herein also encompass any and all overlap, sub-ranges, and combinations thereof, and any specific values within those ranges. Language such as “up to,” “at least,” “greater than,” “less than,” “between,” and the like includes the number recited. Numbers and values used herein preceded by a term such as “about” or “approximately” include the recited numbers. For example, “approximately 7 mm” includes “7 mm” and numbers and ranges preceded by a term such as “about” or “approximately” should be interpreted as disclosing numbers and ranges with or without such a term in front of the number or value such that this application supports claiming the numbers, values and ranges disclosed in the specification and/or claims with or without the term such as “about” or “approximately” before such numbers, values or ranges such, for example, that “approximately two times to approximately five times” also includes the disclosure of the range of “two times to five times.” The scope of the present disclosure is not intended to be limited by the specific disclosures of preferred arrangements in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method of storing at least one fluid, comprising the steps of:
via a production device, providing a desired quantity of at least one fluid to be stored;
transporting the quantity of fluid from the production device into at least one flexible pipe member via at least one fluid import region of the flexible pipe member, the flexible pipe member being windable around a spool element and comprising an inner fluid retaining layer that defines a bore region of the flexible pipe member, an outer sheath disposed over and coaxial with the inner fluid retaining layer and at least one composite reinforcement layer comprising helically wound fibre reinforced thermoplastic tapes that is disposed between the inner fluid retaining layer and the outer sheath;
closing the fluid import region of the flexible pipe member to thereby retain the quantity of fluid in the bore region of the flexible pipe member; and
storing the quantity of fluid at a first pressure in the bore region.

2. The method as claimed in claim 1, further comprising the steps of:
subsequent to closing the fluid import region, at least partially winding the flexible pipe member around a spool element, or prior to transporting the quantity of fluid from the production device into the at least one flexible pipe member, at least partially winding the flexible pipe member around a spool element.

3. The method as claimed in claim 1, further comprising the steps of:
transporting the quantity of fluid from the production device into the bore region via at least one valve element that is disposed at the fluid import region that, in a first configuration, fluidly connects the bore region to a fluid communication region disposed outside of the flexible pipe member.

4. The method as claimed in claim 1, further comprising the steps of:
subsequent to closing the fluid import region and after a storage period of time, removing at least a portion of the quantity of fluid from the flexible pipe member via a fluid export region of the flexible pipe member that optionally is a common region of the flexible pipe member with the fluid import region.

5. The method as claimed in claim 4, further comprising the steps of:
subsequent to removing a portion of the quantity of fluid from the flexible pipe member, via a compressor device, providing the portion of the quantity of fluid to a substantially rigid container and storing compressed fluid in the substantially rigid container at a further pressure that is greater than the first pressure.

6. The method as claimed in claim 1, further comprising the steps of:
locating the flexible pipe member across an onshore region that optionally is above ground or below ground to thereby store the quantity of fluid across said onshore region.

7. The method as claimed in claim 1, further comprising the steps of:
storing the said quantity of fluid at the first pressure that is less than 2000 pounds per square inch (PSI) and optionally is around 1500 PSI.

8. The method as claimed in claim 1, further comprising the steps of:
providing the desired quantity of at least one fluid to be stored as hydrogen that optionally is in a gaseous state and optionally storing a mass from 30 and 50 kg of hydrogen in the bore region of the flexible pipe member that has a volume, that is a fluid storage volume, of around 4795 L along a pipe length of around 990 ft and across a bore diameter of around 5.6 inches.

9. The method as claimed in claim 1, further comprising the steps of:
prior to or during transporting the quantity of fluid from the production device into the at least one flexible pipe member, compressing the quantity of fluid to be at the first pressure that optionally is a predetermined pressure.

10. The method as claimed in claim 1, further comprising the steps of:
limiting permeation of the fluid from the bore region radially towards the outer sheath via a permeation resistant layer that optionally is an integral part of the inner fluid retaining layer, or at least partly coats an outer surface of helical windings of the reinforcement layer.

11. The method as claimed in claim 1, further comprising the steps of:
providing a desired quantity of at least one fluid to be stored via electrolysis of a precursor fluid that optionally is water.

12. Apparatus for storing at last one fluid, comprising:
a flexible pipe member that is at least partially windable around a spool element and that comprises an inner fluid retaining layer that defines a bore region of the flexible pipe member, an outer sheath disposed radially around the inner fluid retaining layer and at least one composite reinforcement layer comprising helically wound fibre reinforced thermoplastic tapes disposed radially between the inner fluid retaining layer and outer sheath; wherein
at least one permeation resistant region of the flexible pipe limits permeation of a desired fluid that is to be stored from the inner bore region radially towards the outer sheath.

13. The apparatus as claimed in claim 12, further comprising:
the flexible pipe member has an outer diameter of around 6 inches, an inner diameter that is a diameter of the bore region of around 5.6 inches and a length of around 990 ft so that the bore has volume, that is a fluid storage volume, of around 4795 L so that at a pressure of around 1500 PSI the flexible pipe member can store a mass from 30 to 50 kg of the desired fluid, the flexible pipe member optionally being disposed across an onshore region that is above ground or below ground so that the desired fluid is stored across the onshore region.

14. The apparatus as claimed in claim 12, further comprising:
at least one valve element that, in a first configuration, permits fluid communication of the desired fluid in the bore region between a first fluid communication region in the bore region and a further fluid communication region external to the flexible pipe member, and, in a further configuration, reduces fluid communication of the desired fluid between the first and further fluid communication regions, and optionally the valve element comprises a one-way valve that is disposed in a first configuration when the desired fluid passes from the further fluid communication region towards the first fluid communication via the valve element.

15. The apparatus as claimed in claim 14, further comprising:
the desired fluid comprises hydrogen that optionally is in a gaseous state in storage, and wherein the valve element in the further configuration is arranged to reduce transport of hydrogen in storage between from the first fluid communication region towards the further fluid communication region.

16. The apparatus as claimed in claim 14, further comprising:
the valve element is selectively operable to permit fluid communication of the desired fluid from the first fluid communication region towards the further fluid communication region and is selectively operable to permit fluid communication of the desired fluid from the further fluid communication region towards the first fluid communication region.

17. The apparatus as claimed in claim 12, further comprising:
the permeation resistant region is integral with the inner fluid retaining layer or at least partly coats an outer surface of helical windings of the reinforcement layer.

18. A flexible fluid storage pipe, comprising:
an inner fluid retaining layer that defines a bore region;
an outer sheath that is disposed over and coaxial with the inner fluid retaining layer and that comprises an outer surface of the flexible fluid storage pipe;
at least one composite reinforcement layer comprising helically wound fibre reinforced thermoplastic tapes disposed between the inner fluid retaining layer and the outer sheath; and
a fluid import region configured to selectively permit transport of fluid into the bore from a region exterior to the flexible fluid storage pipe; wherein
a stored fluid is disposed in the bore region and a permeation resistant region disposed radially within the outer sheath limits permeation of the stored fluid from the bore region towards the outer sheath.

19. The flexible fluid storage pipe as claimed in claim 18, wherein the stored fluid comprises hydrogen that optionally is in a gaseous state.

20. The flexible fluid storage pipe as claimed in claim 19, wherein the flexible fluid storage pipe has an external diameter of around 6 inches, an inner diameter of around 5.6 inches that is a diameter of the bore region, and a length of around 990 ft so that the flexible fluid storage pipe is windable around a spool element and so that the bore region of the flexible fluid storage pipe has a volume, that is a fluid storage volume, of around 4795 L, and at a pressure of around 1500 PSI a mass from 30 to 50 kg of hydrogen can be stored in the flexible fluid storage pipe that optionally is disposed across an onshore region that is above ground or below ground so that the stored fluid is stored across said onshore region.
